(19) United States
(12) Patent Application Publication
(10) Pub. No.: US 2025/0234287 A1
(43) Pub. Date: Jul. 17, 2025

(54) POWER SAVING IN 802.11 DEVICES

(71) Applicant: QUALCOMM Incorporated, San Diego, CA (US)

(72) Inventors: Vivek KUMAR, Bangalore (IN); Pradeep Kumar KOTHA, Bangalore (IN); Prasanna GUNDAPPA, Bangalore (IN); Yongchun XIAO, Fremont, CA (US); Srikant KUPPA, Fremont, CA (US); Sandip HOMCHAUDHURI, San Jose, CA (US); Alfred ASTERJADHI, San Diego, CA (US)

(21) Appl. No.: 18/412,398

(22) Filed: Jan. 12, 2024

(51) Int. Cl. H04W 52/02; H04W 84/12

(52) U.S. Cl. CPC H04W 52/0206; H04W 84/12

(57) ABSTRACT

This disclosure provides methods, components, devices and systems for reducing power consumption of 802.11 wireless nodes. Some aspects more specifically relate to a wireless node configured to transmit a control field in a last data frame, where the control field provides information about a sleep mode plan of the wireless node to a receiving device. In some examples, the control field may include an indication of a sleep duration of the wireless node so that the receiving device can determine its own sleep duration.

### TECHNICAL FIELD

This disclosure relates generally to wireless communications, and more particularly, to power saving techniques for 802.11 wireless nodes.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

Some WLANs may use a target wake time (TWT) to reduce power consumption of wireless nodes. TWT was introduced in Wi-Fi 6 (802.11ax) to improve efficiency of communication between devices (e.g., stations (STAs)) and access points (APs). TWT allows devices to schedule specific times to wake up from a sleep or low power state and communicate with the network, reducing the overall time the devices need to be active. More specifically, with TWT, STAs and APs may negotiate specific time intervals during which the devices can wake up, transmit or receive data, and then return to a sleep state. This targeted approach to waking up devices minimizes the time they spend actively communicating on the network, leading to power savings and more efficient use of the wireless spectrum.

In application, when the traffic ends for current service period (SP), an STA or an AP may transmit a quality of service (QOS) null to inform a peer device that the STA or the AP does not have any more data to transmit. The STA or AP, and in some examples, the peer device, may then enter into a sleep mode for the remaining duration of the SP. If the STA or AP does not have data to transmit for multiple contiguous SPs, then it may transmit a pause frame to enter the sleep mode, then transmit a wake frame to indicate an end of the sleep mode.

However, transmission of the QoS null is only effective for indicating a sleep mode for a current SP, thus if the STA or AP can remain in sleep mode for multiple SPs, the current QoS null is not effective. Moreover, to remain in sleep mode for multiple SPs, the STA or AP must transmit pause and resume frame which require a significant amount of time and power. Thus, there exists a need for further improvements in WLAN technology. These improvements may also be applicable to other multi-access technologies and the telecommunication standards that employ these technologies.

### SUMMARY

The systems, methods and devices of this disclosure each have several innovative aspects, no single one of which is solely responsible for the desirable attributes disclosed herein.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to cause the apparatus to obtain a first series of one or more data frames, wherein a last data frame of the first series comprises a control field indicating a sleep duration beginning after the last data frame. In some examples, the one or more processors are configured to cause the apparatus to enter into a sleep mode, after obtaining the last data frame, for the sleep duration.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors are configured to cause the apparatus to output a first series of one or more data frames for transmission, wherein a last data frame of the first series comprises a control field indicating a sleep duration beginning after the last data frame. In some examples, the one or more processors are configured to cause the apparatus to enter into a sleep mode, after outputting the last data frame, for the sleep duration.

Aspects are directed to a method of wireless communication at a wireless node. In some examples, the method includes obtaining a first series of one or more data frames, wherein a last data frame of the first series comprises a control field indicating a sleep duration beginning after the last data frame. In some examples, the method includes entering into a sleep mode, after obtaining the last data frame, for the sleep duration.

Aspects are directed to a method of wireless communication at a wireless node. In some examples, the method includes outputting a first series of one or more data frames for transmission, wherein a last data frame of the first series comprises a control field indicating a sleep duration beginning after the last data frame. In some examples, the method includes entering into a sleep mode, after outputting the last data frame, for the sleep duration.

Aspects are directed to an apparatus for wireless communication. In some examples, the apparatus includes means for obtaining a first series of one or more data frames, wherein a last data frame of the first series comprises a control field indicating a sleep duration beginning after the last data frame. In some examples, the apparatus includes means for entering into a sleep mode, after obtaining the last data frame, for the sleep duration.

Aspects are directed to an apparatus for wireless communication. In some examples, the apparatus includes means for outputting a first series of one or more data frames for transmission, wherein a last data frame of the first series comprises a control field indicating a sleep duration beginning after the last data frame. In some examples, apparatus includes means for entering into a sleep mode, after outputting the last data frame, for the sleep duration.

Aspects are directed to a non-transitory computer-readable medium comprising instructions that, when executed by a wireless node, cause the wireless node to perform operations. In some examples, the operations include obtaining a first series of one or more data frames, wherein a last data frame of the first series comprises a control field indicating a sleep duration beginning after the last data frame. In some examples, the operations include entering into a sleep mode, after obtaining the last data frame, for the sleep duration.

Aspects are directed to a non-transitory computer-readable medium comprising instructions that, when executed by a wireless node, cause the wireless node to perform operations. In some examples, the operations include outputting a first series of one or more data frames for transmission, wherein a last data frame of the first series comprises a control field indicating a sleep duration beginning after the last data frame. In some examples, the operations include entering into a sleep mode, after outputting the last data frame, for the sleep duration.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 is a block diagram illustrating an example timing schematic of data transmissions made within M service periods (SPs).

FIG. 3 is a block diagram illustrating another example timing schematic of data transmissions made within M service SPs.

FIG. 4 is a table illustrating an example of control ID field values that may be included in the control field of FIG. 3.

FIG. 5 is a call-flow diagram illustrating example communications between an access point (AP) and a station (STA).

FIG. 6 is a timing diagram illustrating an example where a duration of a sleep mode is equal to an intersection of a first time window and a second time window.

FIG. 7 shows a flowchart illustrating an example process performable by or at a wireless node.

FIG. 8 shows a flowchart illustrating another example process performable by or at a wireless node.

FIG. 9 shows a block diagram of an example wireless node.

FIG. 10 shows a block diagram of another example wireless node.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to techniques for reducing signaling overhead and power consumption at wireless nodes. Some aspects more specifically relate to a modified control field of a QoS null or other suitable frame (e.g., QoS data or other management frame) configured to indicate that the wireless node is entering into a sleep mode for a duration of time (e.g., indicated by a time synchronization function (TSF) value or an SP count). Accordingly, a wireless node may transmit an indication of the duration of time at the end of a data transmission notifying a peer device that the wireless node is entering into a sleep mode and providing the peer with the duration of the sleep mode. As such, aspects of the subject matter described in this disclosure can be implemented to realize potential advantages, including reduction of power and signaling overhead by eliminating or reducing transmission of pause and resume frames.

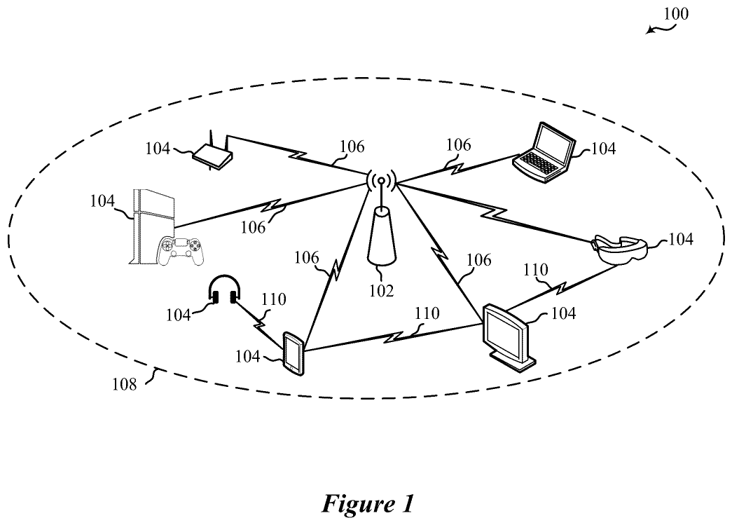

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless nodes within the wireless communication network 100 or to enable such devices to connect to a cellular network's core, such as to access the network management capabilities and functionality offered by the cellular network core.

The wireless communication network 100 may include numerous wireless nodes including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples. As used herein, a wireless node may comprise an STA, an AP, a CU, a DU, or an RU.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHz), FR2 (24.25 GHz-52.6 GHZ), FR3 (7.125 GHz-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Retransmission protocols, such as hybrid automatic repeat request (HARQ), also may offer performance gains. A HARQ protocol may support various HARQ signaling between transmitting and receiving wireless nodes (for example, the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless nodes (including both APs and STAs such as, for example, AP 102 and STAs 104 described in FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some cases, each communication link associated with a given wireless node may be associated with a respective radio of the wireless node, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless nodes in the same direction (such as all uplink or all downlink). In some other examples or durations of time, two or more of the links may be used for communications in different directions. For example, one or more links may support uplink communications and one or more links may support downlink communications. In such examples, at least one of the wireless nodes operates in a full duplex mode. Generally, full duplex operation enables bi-directional communications where at least one of the wireless nodes may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless node, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless node in terms of power consumption. Another benefit of MLO is the increased multiplexing opportunities in the case of a single BSS. For example, multi-link aggregation may increase the number of users per multiplexed transmission served by the multi-link AP MLD.

### Examples of Communicating a Sleep Mode and Wake Up Time

In the context of 802.11 Wi-Fi device functionality, a sleep mode may refer to a power-saving state that a wireless node can enter to conserve energy when it is not actively transmitting or receiving data. This feature may be particularly important for devices with limited power resources, such as battery-powered devices like smartphones, laptops, and IoT (Internet of Things) devices.

When a wireless node is in sleep mode, the device may turn off or reduce power to its radio components (e.g., RF front end), thereby minimizing power consumption during periods of inactivity. In some examples, the wireless node may periodically wake up from sleep mode to check for incoming data or signals from the network. During these wake-up intervals, the device may briefly become active to receive or transmit any pending data. For example, the wireless node may transmit a QoS null frame (e.g., with an end of service period (EOSP) bit) at the end of its data transmission, where the EOSP bit indicates a conclusion of a transmission for the current SP.

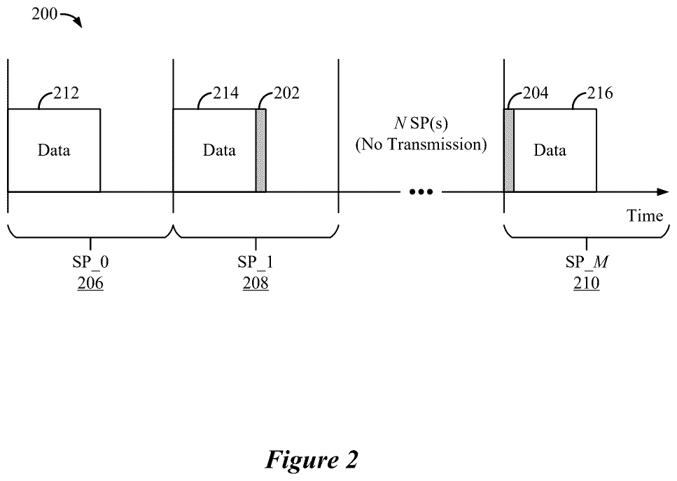

FIG. 2 is a block diagram illustrating an example timing schematic 200 of data transmissions made within M service periods (SPs). Here, a wireless node (e.g., an STA 104 or AP 102) may transmit a first data 212 within a first SP 206 (e.g., SP_0) and a second data 214 is transmitted within a second SP 208 (e.g., SP_1). The second data 214 may be transmitted with a pause frame 202 at the end of the second data 214, where the pause frame 202 indicates that the wireless node has no additional data to transmit and will enter into a sleep mode for a duration of time. It should be noted that the pause frame may not include an indication of the length of the duration of time or an indication of a future SP for which the wireless node will wake up. Thus, the wireless node may enter into a sleep mode for a duration of multiple (N) SPs.

When the wireless node is ready to transmit or receive data again, the wireless node may transmit a resume frame 204. In this example, the wireless node may transmit the resume frame 204 at the beginning of a third data transmission 216 at an Mth SP 210 (e.g., SP_M). The resume frame 204 may be configured to notify another device that the wireless node has ended the sleep mode and is ready to actively transmit and receive communications.

However, transmission of the QoS null with EOSP bit set is only effective for indicating a sleep mode for a current SP. Thus, if the wireless node can remain in sleep mode for multiple SPs, the current QoS null is not effective. Moreover, to remain in sleep mode for multiple SPs, the wireless node must transmit both of the pause frame 202 and the resume frame 204 which results in significant signaling overhead and power consumption at both the wireless node and the receiving device.

### Examples of Enhanced Communication of Sleep Mode and Wake Up Time

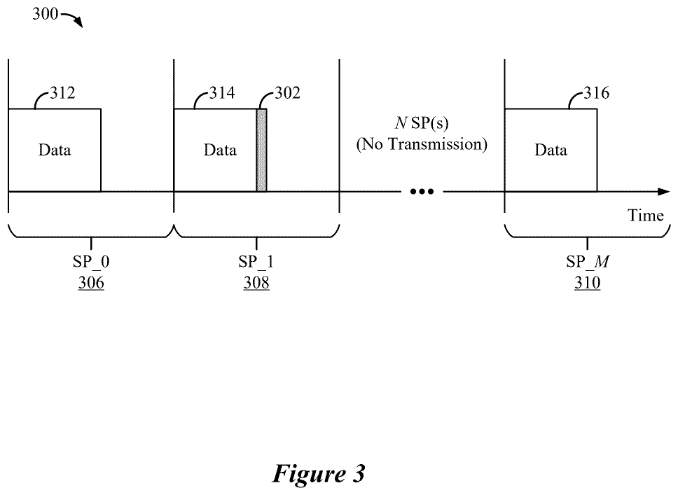

FIG. 3 is a block diagram illustrating another example timing schematic 300 of data transmissions made within M SPs. In some examples, the SPs may be defined in the context of TWT SPs. Here, a wireless node (e.g., an STA 104 or AP 102) may transmit a first data 312 within a first SP 306 (e.g., SP_0) and a second data 314 is transmitted within a second SP 308 (e.g., SP_1). Here, the end of the second data 314 may include a control field 302 (e.g., a high throughput (HT) control, high efficiency (HE) aggregated control (HE A-control)) in the last data frame (e.g., QoS data frame). For example, for a wireless node operating using 802.11ax protocols, the control field may be part of the last QoS data frame, a QoS null frame, a management frame, or any other suitable frame. In another example, for a wireless node operating using pre-802.11ax protocols, the control field 302 may be part of the last QoS data frame and/or QoS null frame, or any other suitable frame.

The control field 302 may be configured to indicate that the wireless node does not have additional data to transmit for the next N SPs. In other words, the control field 302 may indicate that the wireless node intends to enter into a sleep mode for the remaining duration of the second SP 308 and may enter into a wake mode indicated by the control field 302. In some examples, a wake mode may relate to an active state of a device when it is awake and ready to transmit or receive data. Thus, during wake mode, the wireless node may actively communicate with the network and may be involved in data transmission, reception, or other network activities.

In the example illustrated in FIG. 3, the control field 302 may indicate that the wireless node intends to become awake at the Mth SP 310. Thus, the control field 302 may allow the wireless node to notify another STA and/or AP with a beginning and end (e.g., a specific duration) of its sleep mode. As such, the wireless node is not required to transmit either of a pause frame or a separate resume frame at a later time. Accordingly, when the wireless node transmits the third data 316, the device is not required to include an additional frame (e.g., the resume frame 204 of FIG. 2) indicating when it will end its sleep mode or that it is awake.

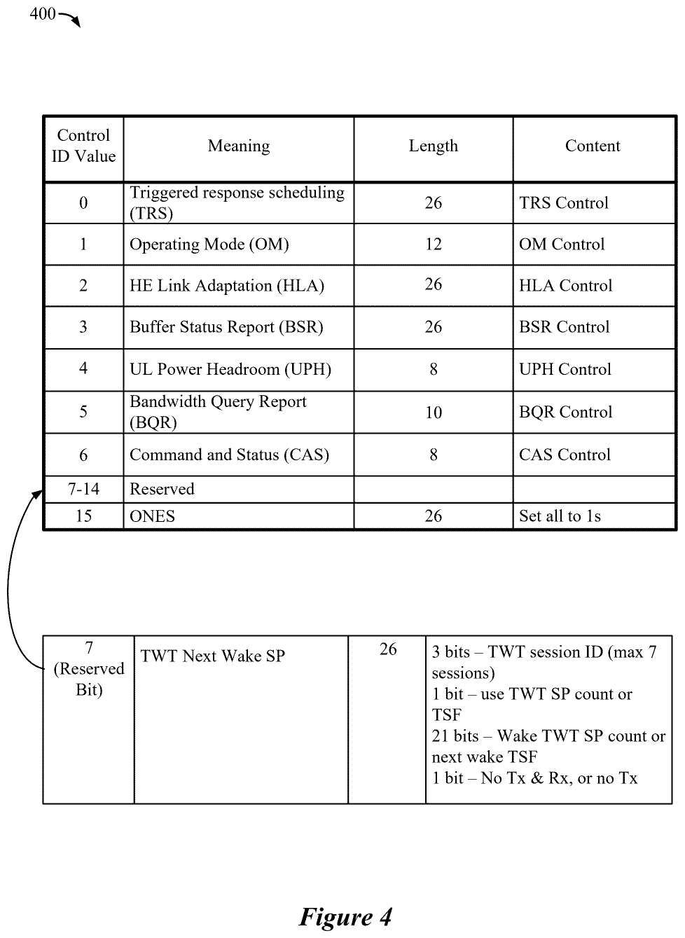

FIG. 4 is a table 400 illustrating an example of control ID field values that may be included in the control field 302 of FIG. 3. As discussed, the control field 302 may include any one or more of the control ID fields and may be an HT control field, an HE A-control field, or any other suitable field, and may be included in a QoS data frame, a QoS null frame, a management or action frame, or any other suitable frame.

The table 400 includes: (i) a control ID value column indicating a value of a control value, (ii) a meaning column indicating a definition of a corresponding control ID value, (iii) a length column indicating a length of control information (e.g., in bits) of a corresponding control ID value, and (iv) a content column indicating the content of the control information of a corresponding control ID value. Control ID values 7-14 are reserved, but any one of values 7-14 may be used by a wireless node to provide a TWT next wake SP. The TWT next wake SP may provide an indication of one or more of a time (e.g., an SP or a TSF) at which the wireless node is beginning a sleep mode, and/or a future time (e.g., a future SP or a TSF) that the wireless node will wake from the sleep mode.

In the illustrated example, reserve bit 7 may be used for TWT next wake SP. Here, the length of TWT next wake SP may be 26 bits. In some examples, there can be maximum 7 TWT sessions. Three of the 26 bits may be used to identify a TWT session ID (e.g., out of max 7 TWT sessions), for which the wireless node transmitting the control field 302 intends to begin a sleep mode.

The wireless node may also use one bit of the TWT next wake SP to indicate to the receiving device that the duration of the sleep mode indicated by TWT next wake SP is in units of SP (e.g., bit set to 0) or TSF (e.g., bit set to 1). For example, if the unit is SP, then the wireless node may further indicate a count (e.g., a number of SPs from the SP indicated by the TWT session ID) to a future SP that the wireless node intends to wake. In another example, if the unit is TSF, then the wireless node may further indicate a future TSF value indicating a time that the wireless node intends to wake.

The wireless node may also use twenty-one bits of the TWT next wake SP to indicate the SP count or the future TSF discussed above. In some examples, twenty-one bits may be used to provide the least significant twenty-one bits of the future TSF. For instance, an STA may set each of the 21 bits as 1 (e.g., 0x1FFFFF), indicating that the STA will begin an indefinite sleep mode duration (e.g., infinite). In this case, if the AP is in receive only mode (e.g., during TWT SP wake duration), then when the STA has data to send, it may end the sleep mode and transmit the data to the AP in the next available TWT SP, and normal TWT transmission and reception between the two devices may resume.

The wireless node may also use one bit of the TWT next wake SP to indicate whether the wireless node is intending to go into a sleep mode where it will neither transmit or receive wireless communications (e.g., bit set to 0), or a sleep mode where it will not transmit wireless signaling but will continue to listen for signaling transmitted to it from other wireless nodes (e.g., bit set to 1).

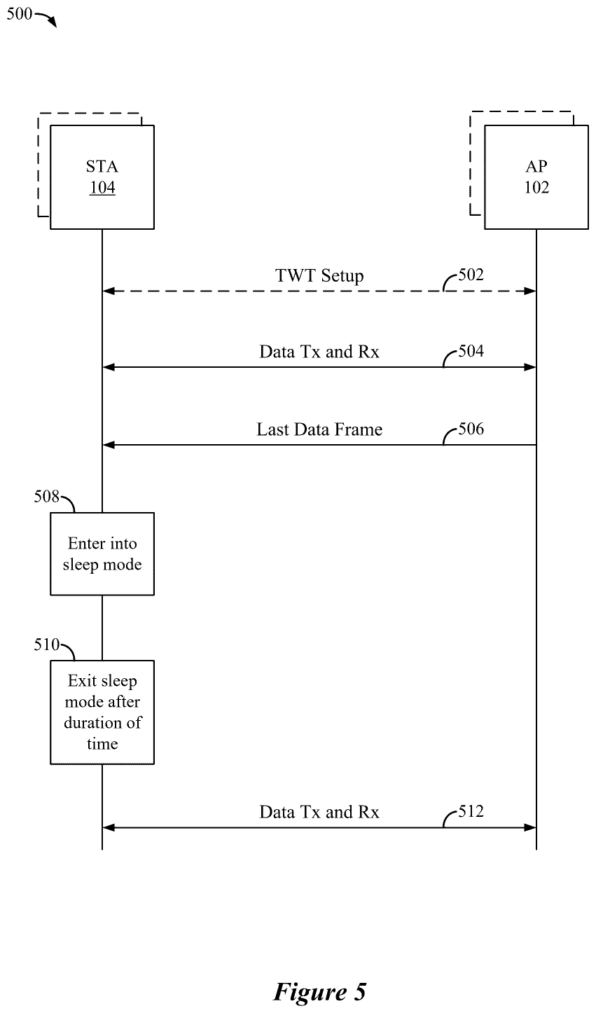

FIG. 5 is a call-flow diagram illustrating example communications 500 between an AP 102 and an STA 104. It should be noted that the AP 102 and the STA 104 are used as examples, and the illustrated communications may be switched (e.g., where the STA 104 is transmitting the control field and the AP 102 is receiving the control field), or where both wireless nodes are APs or STAs.

At an optional first communication 502, the AP 102 may configure the STA 104 to transmit a control field (e.g., control field 302 of FIG. 3 comprising the TWT Next Wake SP field of FIG. 4) indicating a start and end time of the STA's sleep mode, and/or configuring the STA 104 to understand such a control field if the control field is transmitted to the STA 104 from the AP 102 to indicate a sleep mode of the AP 102. In some examples, the STA 104 may query the AP 102 to determine if the AP 102 is configured to understand the control field, and vice versa. If one of the STA 104 or the AP 102 is not configured in this manner, then the other device may transmit signaling to configure the STA 104 or the AP 102 to understand and coherently respond to the control field.

At a second communication 504, the AP 102 and the STA 104 may wirelessly transmit data to the other device and receive data from the other device. For example, the AP 102 may transmit one or more data frames to the STA 104, and the STA 104 may receive the data frame(s) during TWT SPs. At a third communication 506, the STA 104 or the AP 102 may transmit a last data from of a data transmission. Referring back to the aforementioned example, the AP 102 may transmit data to the STA 104 via one or more TWT SPs. Eventually, the AP 102 may transmit a last data frame of the data transmission to the STA 104. Here, the last data frame may include the control field that includes one or more parts of the information associated with the TWT next wake SP of FIG. 4.

In some examples, the control field comprises a count of TWT SPs indicative of a future SP during which the sleep mode of the AP 102 will end, or a TSF value indicating a future time at which the sleep mode will end. For example, the control field may indicate when the AP 102 intends to enter into a sleep mode, whether the duration of the sleep mode is in units of SP or TSF, the duration of the sleep mode (e.g., an indication of a future time the AP 102 intends to exit sleep mode and begin active communications), and/or whether the AP's 102 sleep mode will end both transmission and reception by the AP 102 or if the AP 102 will continue to receive signaling (but not transmit) during the sleep mode. Thus, based on the control field, the STA 104 may enter into a sleep mode for the same duration as the AP 102, and the STA 104 may wake at the end of the duration to receive additional signaling from the AP 102 or to transmit additional signaling to the AP 102.

In some examples, the STA 104 may have signaling to transmit to the AP 102 prior to the duration of the AP's 102 sleep mode ending. In this example, the STA 104 may enter a sleep mode and wake to transmit the data to the AP 102. Thus, the STA 104 may enter a sleep mode for a duration that is shorter than the duration indicated by the AP 102 via the control field. In some examples, the STA 104 may refrain from transmitting the signaling during the sleep duration if the AP 102 transmitted control field indicates that the AP 102 sleep mode will not allow it to transmit or receive data. Accordingly, in such an example, the STA 104 may only transmit data if the AP 102 indicates that it is receiving data during the sleep duration (e.g., if the control field indicates that the AP 102 will continue to receive signaling but will not transmit signaling during the sleep mode). In some examples, the control field may be indicative of the AP 102 having no additional data for transmission to the STA.

In some examples, the AP 102 and STA 104 may be communicating in a multi-link operation. Here, the STA 104 and the AP 102 may communicate using multiple different links. For example, STA 104 and the AP 102 may communicate data frames using a 2.4 GHz link and a 5 GHz link simultaneously. In this example, the control field may identify a particular one or more of the links used by the STA 104 and the AP 102 that will be subject to a sleep mode. Thus, the AP may transmit the control field via either of the 2.4 GHz link or the 5 GHz link, and the control field may identify the 2.4 GHz link as a link that the AP 102 will no longer use for transmission for the indicated duration of the sleep mode. Here, the AP 102 and the STA 104 may continue to communicate via the 5 GHz link, but both may put the 2.4 GHz link in a sleep mode. As such, the AP 102 may only need to transmit the control field via one of the multiple links used for communication instead of both.

In some examples, the AP 102 may be one of multiple APs within communication range of each other, and thus, the AP 102 may share wireless resources with one or more other APs. Here, the AP 102 may cooperate with another AP in order to prevent interference caused by signaling from different STAs or APs using the same frequency resources at the same time. In such an example, the other AP(s) and/or STA(s) may receive the last data frame of the third communication 506 and use the sleep duration indicated thereon to schedule data frame transmissions. By doing this, the other AP(s) and/or STA(s) may opportunistically take advantage of the sleep duration of the AP 102 and STA 104 for their own communications, thereby reducing or eliminating chances of interfering signaling being transmitted.

At a first process 508, the STA 104 may enter into a sleep mode for the duration indicated by the AP 102, or for a duration of time equal to an intersection of: (i) the duration indicated by the AP 102 and (ii) a duration of time that the STA 104 can remain in a sleep mode until a scheduled transmission from the STA 104 to the AP 102. Here, the STA 104 may first determine the duration of the sleep mode based on the aforementioned parameters prior to entering the sleep mode.

At a second process 510, the STA 104 may exit the sleep mode upon the expiration of the determined duration of the sleep mode. If the STA 104 sleep mode duration is the same as the duration indicated by the AP 102 in the control field, then the AP 102 may also exit the sleep mode at the same time.

At a fourth communication 512, the STA 104 and/or AP 102 may resume transmitting and/or receiving data frames after waking from sleep mode.

Accordingly, the STA 104 and AP 102 may transmit an indication of a sleep duration within a control field of a last data frame. This reduces the signaling overhead associated with pause and resume frames, and further reduces other signaling between the two devices. For example, referring back to FIG. 2, upon transmission of the pause frame 202, the device receiving the frame may transmit an ACK message to the transmitting device, and upon transmission of the resume frame 204, the receiving device may again transmit an ACK message to the transmitting device. By including the sleep indication and duration in a control field, the additional ACK signaling is also eliminated, thereby reducing signaling overhead.

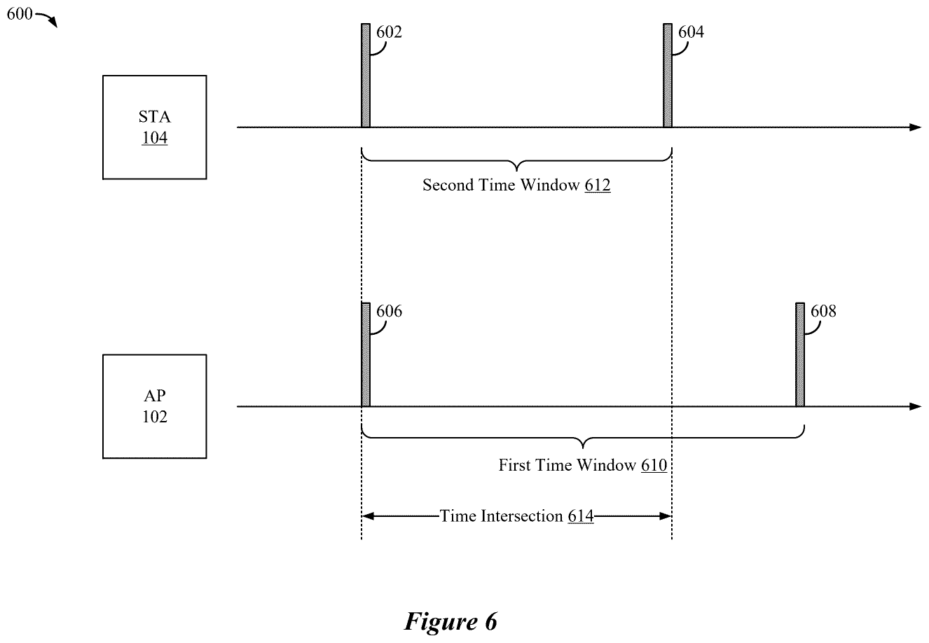

FIG. 6 is a timing diagram illustrating an example where a duration of a sleep mode is equal to an intersection of a first time window 610 and a second time window 612. Here, the AP 102 is in a sleep mode for the first time window 610 which begins at a second time instance 606 and ends at a fourth time instance 608. The STA 104 may be in a sleep mode for the second time window 612 defined by a first time instance 602 and a third time instance 604. The second time window 612 is shorter than the first time window because, for example, the STA 104 may need to transmit data to the AP 102 at the third time instance 604. Thus, the STA 104 may wake up sooner than the AP 102. As such, the sleep duration of the STA 104 may be a duration of a time intersection 614 between the first time window 610 and the second time window 612.

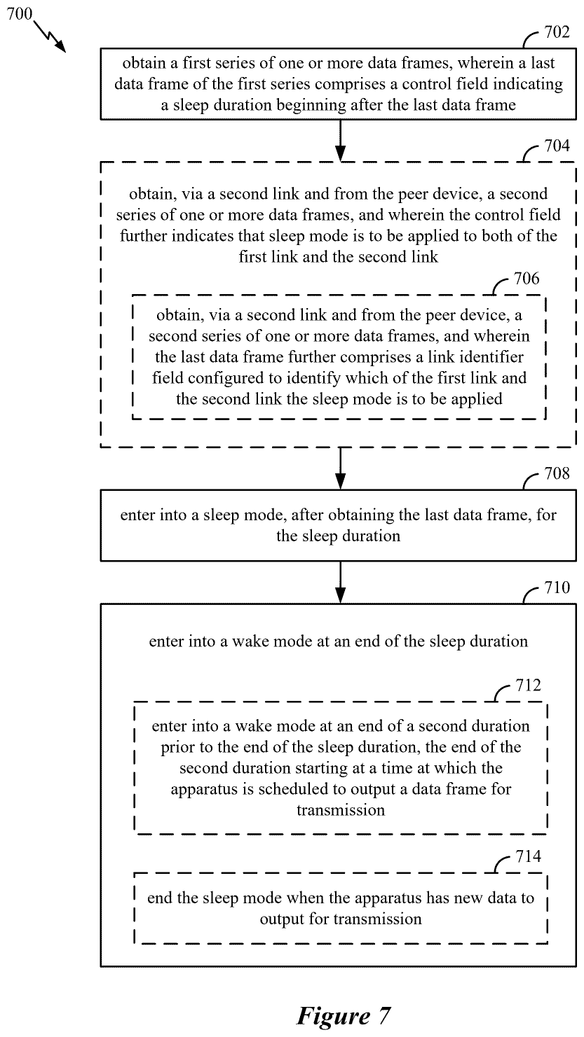

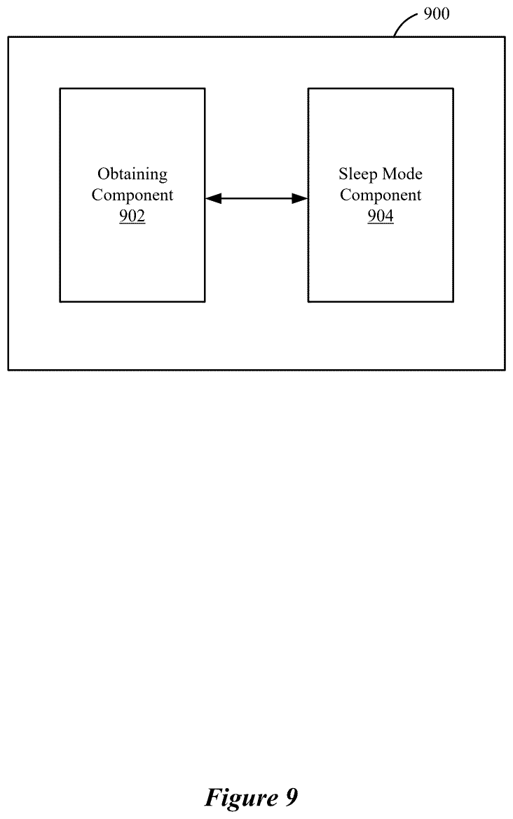

FIG. 7 shows a flowchart illustrating an example process 700 performable by or at a wireless node that supports indicating and entering into sleep mode using a modified control field of a QoS null or other suitable frame (e.g., QoS data or other management frame) configured to indicate that the wireless node is entering into a sleep mode for a duration of time. Accordingly, operations of the process 700 may be implemented by a wireless AP and/or a wireless STA, or its respective components as described herein. For example, the process 700 may be performed by a wireless node, such as the wireless node 900 described with reference to FIG. 9, operating as or within a wireless AP or STA. In some examples, the process 700 may be performed by a wireless AP or STA such as one of the APs 102 and STAs 104 described with reference to FIG. 1.

In some examples, in block 702, the wireless node may obtain a first series of one or more data frames, wherein a last data frame of the first series comprises a control field indicating a sleep duration beginning after the last data frame. Here, the last frame of the series of frames may include a control field configured to indicate that the device (e.g., an AP or STA) transmitting the series of frames is entering into a sleep state, the duration of the sleep state (e.g., a future time the device will wake up from the sleep state), and in some examples, additional information such as whether the device will be able to receive transmissions from the wireless node while in the sleep state. Block 702 may relate to the second communication 504 and the third communication 506 of FIG. 5.

In block 704, the wireless node may optionally obtain, via a second link and from the peer device, a second series of one or more data frames, wherein the control field further indicates that sleep mode is to be applied to both of the first link and the second link. Here, if the wireless node is communicating in an MLO, then the peer device may transmit the indication of the sleep mode via only one link and the wireless node may determine that the sleep mode applies to both links. In some examples, the control field may indicate whether the sleep mode is applied to one or multiple links in an MLO communication.

In block 706, the wireless node may optionally obtain, via a second link and from the peer device, a second series of one or more data frames, and wherein the last data frame further comprises a link identifier field configured to identify which of the first link and the second link the sleep mode is to be applied. Here, the wireless node may receive other signaling from the peer device via a second link (e.g., in an MLO communication). In this example, the other signaling may include a control field configured to indicate which links of the MLO communication will be affected by the sleep mode.

In block 708, the wireless node may enter into a sleep mode, after obtaining the last data frame, for the sleep duration. That is, the wireless node may determine a sleep mode duration based on the control field and may enter into a sleep mode for that duration. Thus mirroring the sleep duration of the peer device. Block 708 may relate to the first process 508 of FIG. 5.

In block 710, the wireless node may enter into a wake mode at an end of the sleep duration. That is, the wireless node may end the sleep duration based on the sleep duration indicated in the control field. Block 710 may relate to the second process 510 of FIG. 5.

In block 712, the wireless node may optionally enter into a wake mode at an end of a second duration prior to the end of the sleep duration, the end of the second duration starting at a time at which the wireless node is scheduled to output a data frame for transmission. Here, the wireless node may be scheduled to transmit data to the peer device at a time prior to the end of the sleep mode indicated by the peer device. In this example, the wireless node may enter into a sleep mode for a shorter duration of time relative to the peer device. Thus, the wireless node may still enter into a sleep mode, but it may exit the sleep mode prior to the peer device so that the wireless node can transmit the data to the peer device. This may occur if the peer device enters into a sleep mode but indicates that it can still receive transmissions while in sleep mode (e.g., where the peer device does not transmit, but can still receive during the sleep mode). Block 712 may relate to the communications illustrated in FIG. 6.

In block 714, the wireless node may optionally end the sleep mode when the wireless node has new data to output for transmission. Here, the wireless node may enter into a sleep mode, but it may exit the sleep mode when it has data to transmit the peer device. This may occur when the sleep mode is indicated as having an indefinite duration, or if the end of the sleep mode duration occurs later than a time when the wireless device is scheduled to transmit data to the peer device. Block 714 may relate to the communications illustrated in FIG. 6.

In certain aspects, the control field is further indicative of a peer device having no additional data for transmission to the apparatus, and the first series of one or more data frames are obtained from the peer device.

In certain aspects, the control field comprises a count of target wake time (TWT) service periods (SPs) indicative of a future SP during which the sleep mode is ended, or the control field comprises a time synchronization function (TSF) value indicating a future time at which the sleep mode is ended.

In certain aspects, the sleep mode is entered at a first time instance; the sleep duration is a duration of time equal to an intersection of a first time window and a second time window; the first time window is a duration of time between the first time instance and a second time instance during which a peer device is scheduled to transmit to the apparatus; and the second time window is a duration of time between the first time instance and a third time instance during which the apparatus is scheduled to transmit to the peer.

In certain aspects, the last data frame comprises either a quality of service (QOS) null frame or a QoS data frame.

In certain aspects, the control field further indicates whether a peer device will: refrain from transmitting signaling and refrain from receiving signaling during the sleep duration; or refrain from transmitting signaling and continue receiving signaling during the sleep duration.

In certain aspects, the control field comprises a target wake time (TWT) identifier configured to identify a service period (SP) during which a peer device enters sleep mode.

In certain aspects, the control field comprises an indication of a measurement unit of the sleep duration, said measurement unit being associated with one or more target wake time (TWT) service periods (SPs) or a time synchronization function (TSF) value.

In certain aspects, the control field comprises an indication of the sleep duration, comprising: a quantity of target wake time (TWT) service periods (SPs); or a wake up time associated with a time synchronization function (TSF) value.

In certain aspects, the indication of the sleep duration comprises the TSF value, and wherein the indication of the sleep duration comprises N least significant bits of the TSF value where the sleep duration ends.

In certain aspects, the sleep duration is indicated as an indefinite duration.

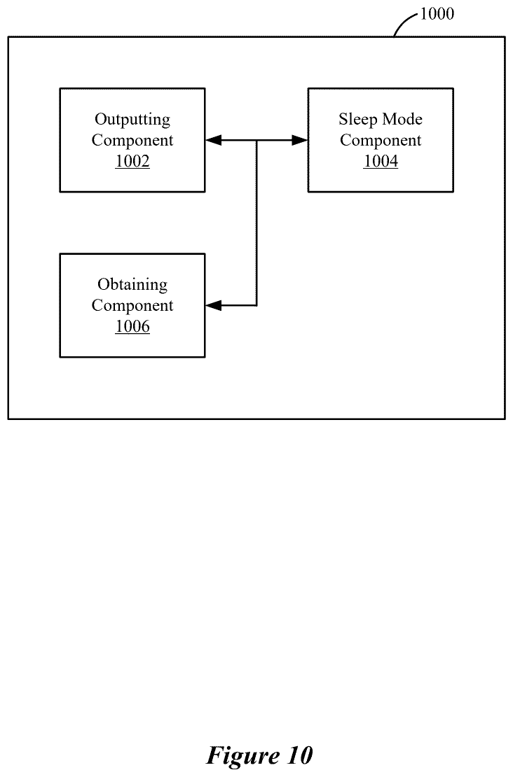

FIG. 7 shows a flowchart illustrating an example process 700 performable by or at a wireless node that supports indicating and entering into sleep mode using a modified control field of a QoS null or other suitable frame (e.g., QoS data or other management frame) configured to indicate that the wireless node is entering into a sleep mode for a duration of time. Accordingly, operations of the process 700 may be implemented by a wireless AP and/or a wireless STA, or its respective components as described herein. For example, the process 700 may be performed by a wireless node, such as the wireless node 1000 described with reference to FIG. 10, operating as or within a wireless AP or STA. In some examples, the process 700 may be performed by a wireless AP or STA such as one of the APs 102 and STAs 104 described with reference to FIG. 1.

In some examples, in block 802, the wireless node may output a first series of one or more data frames for transmission, wherein a last data frame of the first series comprises a control field indicating a sleep duration beginning after the last data frame. Here, the last frame of the series of frames may include a control field configured to indicate that the device (e.g., an AP or STA) transmitting the series of frames is entering into a sleep state, the duration of the sleep state (e.g., a future time the device will wake up from the sleep state), and in some examples, additional information such as whether the device will be able to receive transmissions from the wireless node while in the sleep state. Block 702 may relate to the second communication 504 and the third communication 506 of FIG. 5.

In block 804, the wireless node may optionally output, for transmission to the peer device via a second link, a second series of one or more data frames, and wherein the control field further indicates that sleep mode is to be applied to both of the first link and the second link, wherein the first series of one or more data frames are output for transmission to a peer device via a first link. Here, if the wireless node is communicating in an MLO, then the peer device may transmit the indication of the sleep mode via only one link and the wireless node may determine that the sleep mode applies to both links. In some examples, the control field may indicate whether the sleep mode is applied to one or multiple links in an MLO communication.

In block 806, the wireless node may enter into a sleep mode, after outputting the last data frame, for the sleep duration.

In block 808, the wireless node may optionally obtain, during the sleep duration, one or more additional data frames, wherein the control field further indicates that the apparatus is configured to receive signaling and refrain from transmitting signaling during the sleep duration. Here, a peer device may be scheduled to transmit data to the wireless node at a time prior to the end of the sleep mode. In this example, the peer device may enter into a sleep mode for a shorter duration. Thus, the peer device may still enter into a sleep mode, but it may exit the sleep mode prior to the wireless node. Block 712 may relate to the communications illustrated in FIG. 6.

In block 810, the wireless node may enter into a wake mode at an end of the sleep duration.

In certain aspects, the control field is further indicative of a peer device having no additional data for transmission to the apparatus, and wherein the first series of one or more data frames are obtained from the peer device.

In certain aspects, the control field comprises a count of target wake time (TWT) service periods (SPs) indicative of a future SP during which the sleep mode is ended, or the control field comprises a time synchronization function (TSF) value indicating a future time at which the sleep mode is ended.

In certain aspects, the last data frame comprises either a quality of service (QOS) null frame or a QoS data frame.

In certain aspects, the control field further indicates whether the apparatus will: refrain from transmitting signaling and refrain from receiving signaling during the sleep duration; or refrain from transmitting signaling and continue receiving signaling during the sleep duration.

In certain aspects, the control field comprises a target wake time (TWT) identifier configured to identify a service period (SP) during which the apparatus enters sleep mode.

In certain aspects, the control field comprises in an indication of a measurement unit of the sleep duration, said measurement unit being associated with one or more target wake time (TWT) service periods (SPs) or a time synchronization function (TSF) value.

In certain aspects, the control field comprises in an indication of the sleep duration, comprising: a quantity of target wake time (TWT) service periods (SPs); or a wake up time associated with a time synchronization function (TSF) value.

In certain aspects, the indication of the sleep duration comprises the TSF value, and wherein the indication of the sleep duration comprises N least significant bits of the TSF value where the sleep duration ends.

FIG. 9 shows a block diagram of an example wireless node 900 that supports that supports indicating and entering into sleep mode using a modified control field of a QoS null or other suitable frame (e.g., QoS data or other management frame) configured to indicate that the wireless node is entering into a sleep mode for a duration of time. In some examples, the wireless node 900 is configured to perform the process 700 described with reference to FIG. 7. The wireless node 900 may include one or more chips, SoCs, chipsets, packages, components or devices that individually or collectively constitute or comprise a processing system. The processing system may interface with other components of the wireless node 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 900 may transmit the information output from the chip. In such an example, the second interface may refer to an interface between the processing system of the chip and a reception component, such that the device 900 may receive information that is passed to the processing system. In some such examples, the first interface also may obtain information, such as from the transmission component, and the second interface also may output information, such as to the reception component.

The processing system of the wireless node 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless node 900 can be configurable or configured for use in an AP and/or STA, such as the AP 102 and STA 104 described with reference to FIG. 1. In some other examples, the wireless node 900 can be an AP and/or STA that includes such a processing system and other components including multiple antennas. The wireless node 900 is capable of transmitting and receiving wireless communications in the form of, for example, wireless packets. For example, the wireless node 900 can be configurable or configured to transmit and receive packets in the form of physical layer PPDUs and MPDUs conforming to one or more of the IEEE 802.11 family of wireless communication protocol standards. In some other examples, the wireless node 900 can be configurable or configured to transmit and receive signals and communications conforming to one or more 3GPP specifications including those for 5G NR or 6G. In some examples, the wireless node 900 also includes or can be coupled with one or more application processors which may be further coupled with one or more other memories. In some examples, the wireless node 900 further includes at least one external network interface coupled with the processing system that enables communication with a core network or backhaul network that enables the wireless node 900 to gain access to external networks including the Internet.

The wireless node 900 includes an obtaining component 902 and a sleep mode component 904. Portions of one or more of the components 902 and 904 may be implemented at least in part in hardware or firmware. For example, the obtaining component 902 and the sleep mode component 904 may be implemented at least in part by a processor or a modem. In some examples, portions of one or more of the components 902 and 904 may be implemented at least in part by a processor and software in the form of processor-executable code stored in a memory.

The obtaining component 902 is configurable or configured to: obtain a first series of one or more data frames, wherein a last data frame of the first series comprises a control field indicating a sleep duration beginning after the last data frame; obtain, via a second link and from the peer device, a second series of one or more data frames, and wherein the control field further indicates that sleep mode is to be applied to both of the first link and the second link; and obtain, via a second link and from the peer device, a second series of one or more data frames, and wherein the last data frame further comprises a link identifier field configured to identify which of the first link and the second link the sleep mode is to be applied.

The sleep mode component 904 is configurable or configured to enter into a sleep mode, after obtaining the last data frame, for the sleep duration; enter into a wake mode at an end of the sleep duration; enter into a wake mode at an end of a second duration prior to the end of the sleep duration, the end of the second duration starting at a time at which the apparatus is scheduled to output a data frame for transmission; and end the sleep mode when the apparatus has new data to output for transmission.

Means for transmitting and receiving or means for outputting for transmission and obtaining may include a radio of the wireless node discussed above in relation to FIG. 1, which may include one or more transmit/receive (Tx/Rx) chains, include or be coupled with one or more physical antennas, and/or include signal processing components and/or modems, among other components. Means for entering sleep mode and means for ending sleep mode may include a processing system, which may include the processor (or “processing”) circuitry discussed above in reference to FIG. 9.

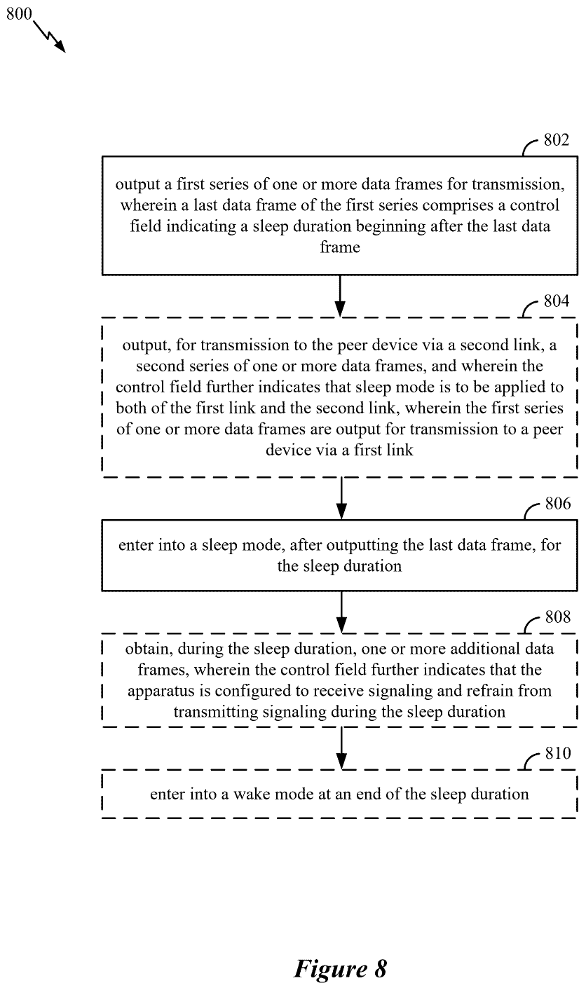

FIG. 10 shows a block diagram of an example wireless node 1000 that supports indicating and entering into sleep mode using a modified control field of a QoS null or other suitable frame (e.g., QoS data or other management frame) configured to indicate that the wireless node is entering into a sleep mode for a duration of time. In some examples, the wireless node 1000 is configured to perform the process 800 described with reference to FIG. 8. The wireless node 1000 may include one or more chips, SoCs, chipsets, packages, components or devices that individually or collectively constitute or comprise a processing system. The processing system may interface with other components of the wireless node 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless node 1000 may transmit the information output from the chip. In such an example, the second interface may refer to an interface between the processing system of the chip and a reception component, such that the wireless node 1000 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless node 1000 can be configurable or configured for use in a STA and/or an AP, such as the STA 104 and AP 102 described with reference to FIG. 1. In some other examples, the wireless node 1000 can be a STA or AP that includes such a processing system and other components including multiple antennas. The wireless node 1000 is capable of transmitting and receiving wireless communications in the form of, for example, wireless packets. For example, the wireless node 1000 can be configurable or configured to transmit and receive packets in the form of physical layer PPDUs and MPDUs conforming to one or more of the IEEE 802.11 family of wireless communication protocol standards. In some other examples, the wireless node 1000 can be configurable or configured to transmit and receive signals and communications conforming to one or more 3GPP specifications including those for 5G NR or 6G. In some examples, the wireless node 1000 also includes or can be coupled with one or more application processors which may be further coupled with one or more other memories. In some examples, the wireless node 1000 further includes a user interface (UI) (such as a touchscreen or keypad) and a display, which may be integrated with the UI to form a touchscreen display that is coupled with the processing system. In some examples, the wireless node 1000 may further include one or more sensors such as, for example, one or more inertial sensors, accelerometers, temperature sensors, pressure sensors, or altitude sensors, that are coupled with the processing system.

The wireless node 1000 includes an outputting component 1002, a sleep mode component 1004, and an obtaining component 1006. Portions of one or more of the components 1002, 1004, and 1006 may be implemented at least in part in hardware or firmware. For example, the outputting component 1002, the sleep mode component 1004, and the obtaining component 1006 may be implemented at least in part by a processor or a modem. In some examples, portions of one or more of the components 1002, 1004, and 1006 may be implemented at least in part by a processor and software in the form of processor-executable code stored in the memory.

The outputting component 1002 is configurable or configured to output a first series of one or more data frames for transmission, wherein a last data frame of the first series comprises a control field indicating a sleep duration beginning after the last data frame; and output, for transmission to the peer device via a second link, a second series of one or more data frames, and wherein the control field further indicates that sleep mode is to be applied to both of the first link and the second link, wherein the first series of one or more data frames are output for transmission to a peer device via a first link.

The sleep mode component 1004 is configurable or configured to enter into a sleep mode, after outputting the last data frame, for the sleep duration; and enter into a wake mode at an end of the sleep duration.

The obtaining component 1006 is configurable or configured to obtain, during the sleep duration, one or more additional data frames, wherein the control field further indicates that the apparatus is configured to receive signaling and refrain from transmitting signaling during the sleep duration.

Means for transmitting and receiving or means for outputting for transmission and obtaining may include a radio of the wireless node discussed above in relation to FIG. 1, which may include one or more transmit/receive (Tx/Rx) chains, include or be coupled with one or more physical antennas, and/or include signal processing components and/or modems, among other components. Means for entering sleep mode and means for ending sleep mode may include a processing system, which may include the processor (or “processing”) circuitry discussed above in reference to FIG. 9.

Implementation examples are described in the following numbered clauses.

### EXAMPLE CLAUSES

Clause 1: A method of wireless communication at a wireless node, comprising: obtaining a first series of one or more data frames, wherein a last data frame of the first series comprises a control field indicating a sleep duration beginning after the last data frame; and entering into a sleep mode, after obtaining the last data frame, for the sleep duration.

Clause 2: The method of clause 1, wherein the control field is further indicative of a peer device having no additional data for transmission to the wireless node, and wherein the first series of one or more data frames are obtained from the peer device.

Clause 3: The method of any of clauses 1 and 2, wherein: the control field comprises a count of target wake time (TWT) service periods (SPs) indicative of a future SP during which the sleep mode is ended, or the control field comprises a time synchronization function (TSF) value indicating a future time at which the sleep mode is ended.

Clause 4: The method of any of clauses 1-3, further comprising: entering into a wake mode at an end of the sleep duration.

Clause 5: The method of any of clauses 1-4, further comprising: entering into a wake mode at an end of a second duration prior to the end of the sleep duration, the end of the second duration starting at a time at which the wireless node is scheduled to output a data frame for transmission.

Clause 6: The method of any of clauses 1-5, wherein: the sleep mode is entered at a first time instance; the sleep duration is a duration of time equal to an intersection of a first time window and a second time window; the first time window is a duration of time between the first time instance and a second time instance during which a peer device is scheduled to transmit to the wireless node; and the second time window is a duration of time between the first time instance and a third time instance during which the wireless node is scheduled to transmit to the peer.

Clause 7: The method of any of clauses 1-6, wherein the last data frame comprises either a quality of service (QOS) null frame or a QoS data frame.

Clause 8: The method of any of clauses 1-7, wherein the control field further indicates whether a peer device will: refrain from transmitting signaling and refrain from receiving signaling during the sleep duration; or refrain from transmitting signaling and continue receiving signaling during the sleep duration.

Clause 9: The method of any of clauses 1-8, wherein the control field comprises a target wake time (TWT) identifier configured to identify a service period (SP) during which a peer device enters sleep mode.

Clause 10: The method of any of clauses 1-9, wherein the control field comprises an indication of a measurement unit of the sleep duration, said measurement unit being associated with one or more target wake time (TWT) service periods (SPs) or a time synchronization function (TSF) value.

Clause 11: The method of any of clauses 1-10 wherein the control field comprises an indication of the sleep duration, comprising: a quantity of target wake time (TWT) service periods (SPs); or a wake up time associated with a time synchronization function (TSF) value.

Clause 12: The method of clause 11, wherein the indication of the sleep duration comprises the TSF value, and wherein the indication of the sleep duration comprises N least significant bits of the TSF value where the sleep duration ends.

Clause 13: The method of any of clauses 1-12, wherein the sleep duration is indicated as an indefinite duration, and wherein the method further comprises: ending the sleep mode when the wireless node has new data to output for transmission.

Clause 14: The method of any of clauses 1-13, wherein the first series of one or more data frames are obtained via a first link and from a peer device, and wherein the method further comprises: obtaining, via a second link and from the peer device, a second series of one or more data frames, and wherein the control field further indicates that sleep mode is to be applied to both of the first link and the second link.

Clause 15: The method of any of clauses 1-14, wherein the first series of one or more data frames are obtained via a first link and from a peer device, and wherein the method further comprises: obtaining, via a second link and from the peer device, a second series of one or more data frames, and wherein the last data frame further comprises a link identifier field configured to identify which of the first link and the second link the sleep mode is to be applied.

Clause 16: A method of wireless communication at a wireless node, comprising: outputting a first series of one or more data frames for transmission, wherein a last data frame of the first series comprises a control field indicating a sleep duration beginning after the last data frame; and entering into a sleep mode, after outputting the last data frame, for the sleep duration.

Clause 17: The method of clause 16, wherein the control field is further indicative of a peer device having no additional data for transmission to the apparatus, and wherein the first series of one or more data frames are obtained from the peer device.

Clause 18: The method of any of clauses 16 and 17, wherein: the control field comprises a count of target wake time (TWT) service periods (SPs) indicative of a future SP during which the sleep mode is ended, or the control field comprises a time synchronization function (TSF) value indicating a future time at which the sleep mode is ended.

Clause 19: The method of any of clauses 16-18, further comprising: entering into a wake mode at an end of the sleep duration.

Clause 20: The method of any of clauses 16-19, further comprising: obtaining, during the sleep duration, one or more additional data frames, wherein the control field further indicates that the apparatus is configured to receive signaling and refrain from transmitting signaling during the sleep duration.

Clause 21: The method of any of clauses 16-20, wherein the last data frame comprises either a quality of service (QOS) null frame or a QoS data frame.

Clause 22: The method of any of clauses 16-21, wherein the control field further indicates whether the apparatus will: refrain from transmitting signaling and refrain from receiving signaling during the sleep duration; or refrain from transmitting signaling and continue receiving signaling during the sleep duration.

Clause 23: The method of any of clauses 16-22, wherein the control field comprises a target wake time (TWT) identifier configured to identify a service period (SP) during which the apparatus enters sleep mode.

Clause 24: The method of any of clauses 16-23, wherein the control field comprises in an indication of a measurement unit of the sleep duration, said measurement unit being associated with one or more target wake time (TWT) service periods (SPs) or a time synchronization function (TSF) value.

Clause 25: The method of any of clauses 16-24, wherein the control field comprises in an indication of the sleep duration, comprising: a quantity of target wake time (TWT) service periods (SPs); or a wake up time associated with a time synchronization function (TSF) value.

Clause 26: The method of clause 25, wherein the indication of the sleep duration comprises the TSF value, and wherein the indication of the sleep duration comprises N least significant bits of the TSF value where the sleep duration ends.

Clause 27: The method of any of clauses 16-26, wherein the first series of one or more data frames are output for transmission to a peer device via a first link, and wherein the method further comprises: outputting, for transmission to the peer device via a second link, a second series of one or more data frames, and wherein the control field further indicates that sleep mode is to be applied to both of the first link and the second link.

Clause 28: An apparatus for wireless communications, comprising means for performing a method in accordance with any one of clauses 1-15.

Clause 29: An apparatus for wireless communications, comprising means for performing a method in accordance with any one of clauses 16-27.

Clause 30: A non-transitory computer-readable medium comprising instructions that, when executed by a wireless node, cause the wireless node to perform a method in accordance with any one of clauses 1-15.

Clause 31: A non-transitory computer-readable medium comprising instructions that, when executed by a wireless node, cause the wireless node to perform a method in accordance with any one of clauses 19-26.

Clause 32: An apparatus for wireless communications, comprising: one or more memories, individually or in combination, having instructions; and one or more processors, individually or in combination, configured to execute the instructions and cause the apparatus to perform a method in accordance with any one of clauses 1-15.

Clause 33: An apparatus for wireless communications, comprising: one or more memories, individually or in combination, having instructions; and one or more processors, individually or in combination, configured to execute the instructions and cause the apparatus to perform a method in accordance with any one of clauses 16-27.

Clause 34: A wireless node, comprising: a transceiver; one or more memories, individually or in combination, having instructions; and one or more processors, individually or in combination, configured to execute the instructions and cause the wireless node to perform a method in accordance with any one of clauses 1-15, wherein the transceiver is configured to: receive the first series of one or more data frames.

Clause 35: A wireless node, comprising: a transceiver; one or more memories, individually or in combination, having instructions; and one or more processors, individually or in combination, configured to execute the instructions and cause the network entity to perform a method in accordance with any one of clauses 16-27, wherein the transceiver is configured to: transmit the first series of one or more data frames.

### Additional Considerations

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
one or more memories, individually or in combination, having instructions; and
one or more processors, individually or in combination, configured to execute the instructions and cause the apparatus to:
obtain a first series of one or more data frames, wherein a last data frame of the first series comprises a control field indicating a sleep duration beginning after the last data frame; and
enter into a sleep mode, after obtaining the last data frame, for the sleep duration.

2. The apparatus of claim 1, wherein the control field is further indicative of a peer device having no additional data for transmission to the apparatus, and wherein the first series of one or more data frames are obtained from the peer device.

3. The apparatus of claim 1, wherein:
the control field comprises a count of target wake time (TWT) service periods (SPs) indicative of a future SP during which the sleep mode is ended, or
the control field comprises a time synchronization function (TSF) value indicating a future time at which the sleep mode is ended.

4. The apparatus of claim 1, wherein the one or more processors, individually or in combination, are further configured to:
enter into a wake mode at an end of the sleep duration.

5. The apparatus of claim 1, wherein the one or more processors, individually or in combination, are further configured to:
enter into a wake mode at an end of a second duration prior to the end of the sleep duration, the end of the second duration starting at a time at which the apparatus is scheduled to output a data frame for transmission.

6. The apparatus of claim 1, wherein:
the sleep mode is entered at a first time instance;
the sleep duration is a duration of time equal to an intersection of a first time window and a second time window;
the first time window is a duration of time between the first time instance and a second time instance during which a peer device is scheduled to transmit to the apparatus; and
the second time window is a duration of time between the first time instance and a third time instance during which the apparatus is scheduled to transmit to the peer.

7. The apparatus of claim 1, wherein the last data frame comprises either a quality of service (QOS) null frame or a QoS data frame.

8. The apparatus of claim 1, wherein the control field further indicates whether a peer device will:
refrain from transmitting signaling and refrain from receiving signaling during the sleep duration; or
refrain from transmitting signaling and continue receiving signaling during the sleep duration.

9. The apparatus of claim 1, wherein the control field comprises a target wake time (TWT) identifier configured to identify a service period (SP) during which a peer device enters sleep mode.

10. The apparatus of claim 1, wherein the control field comprises an indication of a measurement unit of the sleep duration, said measurement unit being associated with one or more target wake time (TWT) service periods (SPs) or a time synchronization function (TSF) value.

11. The apparatus of claim 1, wherein the control field comprises an indication of the sleep duration, comprising:
a quantity of target wake time (TWT) service periods (SPs); or
a wake up time associated with a time synchronization function (TSF) value.

12. The apparatus of claim 11, wherein the indication of the sleep duration comprises the TSF value, and wherein the indication of the sleep duration comprises N least significant bits of the TSF value where the sleep duration ends.

13. The apparatus of claim 1, wherein the sleep duration is indicated as an indefinite duration, and wherein the one or more processors, individually or in combination, are further configured to cause the apparatus to:
end the sleep mode when the apparatus has new data to output for transmission.

14. The apparatus of claim 1, wherein the first series of one or more data frames are obtained via a first link and from a peer device, and wherein the one or more processors, individually or in combination, are further configured to:
obtain, via a second link and from the peer device, a second series of one or more data frames, and wherein the control field further indicates that sleep mode is to be applied to both of the first link and the second link.

15. The apparatus of claim 1, wherein the first series of one or more data frames are obtained via a first link and from a peer device, and wherein the one or more processors, individually or in combination, are further configured to:
obtain, via a second link and from the peer device, a second series of one or more data frames, and wherein the last data frame further comprises a link identifier field configured to identify which of the first link and the second link the sleep mode is to be applied.

16. The apparatus of claim 1, further comprising a transceiver configured to:
receive the first series of one or more data frames, wherein the apparatus is configured as a station (STA).

17. An apparatus for wireless communication, comprising:
one or more memories, individually or in combination, having instructions; and
one or more processors, individually or in combination, configured to execute the instructions and cause the apparatus to:
output a first series of one or more data frames for transmission, wherein a last data frame of the first series comprises a control field indicating a sleep duration beginning after the last data frame; and
enter into a sleep mode, after outputting the last data frame, for the sleep duration.

18. The apparatus of claim 17, wherein the control field is further indicative of a peer device having no additional data for transmission to the apparatus, and wherein the first series of one or more data frames are obtained from the peer device.

19. The apparatus of claim 17, wherein:
the control field comprises a count of target wake time (TWT) service periods (SPs) indicative of a future SP during which the sleep mode is ended, or
the control field comprises a time synchronization function (TSF) value indicating a future time at which the sleep mode is ended.

20. The apparatus of claim 17, wherein the one or more processors, individually or in combination, are further configured to:
enter into a wake mode at an end of the sleep duration.

21. The apparatus of claim 17, wherein the one or more processors, individually or in combination, are further configured to:
obtain, during the sleep duration, one or more additional data frames, wherein the control field further indicates that the apparatus is configured to receive signaling and refrain from transmitting signaling during the sleep duration.

22. The apparatus of claim 17, wherein the last data frame comprises either a quality of service (QOS) null frame or a QoS data frame.

23. The apparatus of claim 17, wherein the control field further indicates whether the apparatus will:
refrain from transmitting signaling and refrain from receiving signaling during the sleep duration; or
refrain from transmitting signaling and continue receiving signaling during the sleep duration.

24. The apparatus of claim 17, wherein the control field comprises a target wake time (TWT) identifier configured to identify a service period (SP) during which the apparatus enters sleep mode.

25. The apparatus of claim 17, wherein the control field comprises in an indication of a measurement unit of the sleep duration, said measurement unit being associated with one or more target wake time (TWT) service periods (SPs) or a time synchronization function (TSF) value.

26. The apparatus of claim 17, wherein the control field comprises in an indication of the sleep duration, comprising:
a quantity of target wake time (TWT) service periods (SPs); or
a wake up time associated with a time synchronization function (TSF) value.

27. The apparatus of claim 26, wherein the indication of the sleep duration comprises the TSF value, and wherein the indication of the sleep duration comprises N least significant bits of the TSF value where the sleep duration ends.

28. The apparatus of claim 17, wherein the first series of one or more data frames are output for transmission to a peer device via a first link, and wherein the one or more processors, individually or in combination, are further configured to:
output, for transmission to the peer device via a second link, a second series of one or more data frames, and wherein the control field further indicates that sleep mode is to be applied to both of the first link and the second link.

29. The apparatus of claim 17, further comprising a transceiver configured to:
transmit the first series of one or more data frames, wherein the apparatus is configured as an access point (AP).

30. A method for wireless communications at a wireless node, comprising:
obtaining a first series of one or more data frames, wherein a last data frame of the first series comprises a control field indicating a sleep duration beginning after the last data frame; and
enter into a sleep mode, after obtaining the last data frame, for the sleep duration.
